(19) United States
(12) Patent Application Publication
(10) Pub. No.: US 2026/0129037 A1
(43) Pub. Date: May 7, 2026

(54) System and Method for Enacting Authorized Mimicking of Authenticated Sessions in Web-Based Applications

(71) Applicant: CHEWY, INC., Plantation, FL (US)

(72) Inventors: Benjamin Hussey, Chicago, IL (US); Shashank Buch, Boston, MA (US); Gaurav Gulati, Boston, MA (US); Pragya Dixit, Boston, MA (US)

(73) Assignee: CHEWY, INC., Plantation, FL (US)

(21) Appl. No.: 19/361,236

(22) Filed: Oct. 17, 2025

Related U.S. Application Data
(60) Provisional application No. 63/716,452, filed on Nov. 5, 2024.

(51) Int. Cl. H04L 9/40

(52) U.S. Cl. CPC H04L 63/083; H04L 63/1433

(57) ABSTRACT

A method includes receiving, a request to mimic an authenticated session between a target device and a web application hosted at a web server. The method includes receiving a request from a UI gateway for an enactment authentication token and the request includes a target device identifier and a token associated with the enactment device. The method includes providing the enactment authentication token to the UI gateway. At a proxy server being at the same internet domain as the web server, a request is received to access an enactment session with the web application at the enactment device, the request includes the enactment authentication token. The enactment session is created between the enactment device and the web application. The enactment session between the enactment device and the web application mimics an authenticated session between the web application and the target device.

### CROSS-REFERENCE TO RELATED APPLICATIONS

This application claims the benefit of U.S. Provisional Ser. No. 63/716,452 filed Nov. 5, 2024 entitled “System and Method for Enacting Authorized Mimicking of Authenticated Sessions in Web-Based Applications”, which is incorporated by reference herein in its entirety.

### TECHNICAL FIELD

The present disclosure generally relates to systems for enacting authorized mimicking of authenticated sessions in web-based applications.

### SUMMARY

In one embodiment there is a method including receiving, at a UI gateway, a request from an enactment device to mimic an authenticated session between a target device and a web application hosted at a web server, the target device having a target device identifier, receiving, at a company-specific authorization account endpoint, a request from the UI gateway for an enactment authentication token, the request including the target device identifier and a token associated with the enactment device, providing, by the company-specific authorization account endpoint, the enactment authentication token to the UI gateway, receiving via the UI gateway, at a proxy server being at the same internet domain as the web server, a request to access an enactment session with the web application at the enactment device, the request including the enactment authentication token, creating, at the web server, via the proxy server, the enactment session between the enactment device and the web application, the enactment session between the enactment device and the web application mimics an authenticated session between the web application and the target device.

In some embodiments, the method further includes receiving, at the web server, a request from the target device to access an authenticated session of the web application, and creating, by the web server, the authenticated session between the target device and the web application. In some embodiments the method further includes detecting, at the UI gateway, a request to release access to the authenticated session of the web application for the target device, enabling, by the UI gateway, at least one function of the authenticated session of the web application for the target device previously disabled by the UI gateway, transmitting a release access request from the UI gateway to the web server, and clearing, by the web server, the enactment session between the enactment device and the web application, wherein clearing the enactment session includes deleting an access token cookie and a session token cookie.

In some embodiments, the request to release access to the instance of the web application intended for the target device is a mouse-out or mouse-over event detected by the UI gateway. In some embodiments, transmitting a release access request includes, by the UI gateway, transmitting the request to an inline frame embedded in the UI gateway that is on the internet domain of the web application. In some embodiments the method further includes disabling, by the UI gateway, at least one function of the authenticated session between the target device and the web application. In some embodiments, the at least one function includes a cart function for the web application. In some embodiments, the web application includes a plurality of single page applications hosted by the web server at the same internet domain as the proxy server.

In some embodiments, the web server restricts requests for session creation of the web application from servers operating on a different internet domain and wherein the UI gateway is a server that operates on a different internet domain than the web server. In some embodiments, the enactment authentication token provided to the UI gateway includes one or more of: a unique identifier of the enactment device, a permission identifier, and the target device identifier. In some embodiments, creating the enactment session includes setting an access token cookie and a session cookie specific to the enactment device.

In another embodiment there is a method including receiving, from a UI gateway, a request from an enactment device to mimic an authenticated session between a web application hosted by a web server and a target device, wherein the UI gateway includes an inline frame embedding a web-shell single-page application (SPA) therein, wherein the web-shell SPA is configured to connect the UI gateway to the web server, wherein the UI gateway operates on a different internet domain than the web-shell SPA and the web server and wherein the web server restricts direct access to the web application for the UI gateway, transmitting, from the web server to the inline frame, a respective web page of the web application, displaying at the enactment device in communication with the UI gateway the web application including the inline frame embedding the web-shell single-page application and an inline frame hosting the respective web page of the web application, detecting a user action at the enactment device at the inline frame hosting the web page of the web application, and in response to detecting the user action, modifying a connection of the target device and the enactment device to the web application.

In some embodiments, the web-shell single-page application includes an inline frame including web pages of the web application. In some embodiments, modifying a connection of the enactment device to the web application includes connecting the enactment device to a session with the web application that mimics an authentication of the target device, and connecting the enactment device to the session of the web application includes one of creating a session token and refreshing already-created session token for the enactment device. In some embodiments, the method further includes disconnecting the enactment device from the session with the web application that mimics authentication of the target device, connecting the target device to a session with the web application, and connecting the enactment device to a session with the web application that mimics authentication of a second target device.

In some embodiments, modifying a connection of the enactment device to the web application includes disconnecting the enactment device from a session of the web application that mimics an authentication of the target device, disconnecting the enactment device from the session of the web application includes connecting the target device to another session of the web application, and connecting the target device to the session of the web application includes creating or refreshing already created session tokens for the target device. In some embodiments, the user action is a mouse-over action at a perimeter of the inline frame hosting the web page of the web application. In some embodiments, the user action is a mouse-out action outside of a perimeter of the inline frame hosting the web page of the web application. In some embodiments, the method further includes detecting and modifying one or more elements of the respective web page at the web-shell SPA before displaying the respective web page at the enactment device.

In another embodiment there is a method including receiving, from a UI gateway, a request from an enactment device to mimic an authenticated session between a web application and a target device, the web application being hosted by a web server, wherein the UI gateway includes an inline frame embedding a web-shell single-page application (SPA) therein, wherein the web-shell SPA is configured to connect the UI gateway to the web server, wherein the UI gateway operates on a different internet domain than the web-shell SPA and the web server and wherein the web server restricts direct access to the web application for the UI gateway, transmitting, from the web server to the inline frame, a single page application of the web application, the web application including a plurality of single page applications hosted at the same internet domain, at the web-shell SPA, modifying the single page application of the web application, and displaying at the enactment device in communication with the UI gateway, the modified single page application of web application at the inline frame.

In some embodiments, there is a system including a UI gateway configured to receive a request from an enactment device to mimic an authenticated session between a target device and a web application hosted at a web server, the target device having a target device identifier, a company-specific authorization account endpoint configured to receive a request from the UI gateway for an enactment authentication token, the request including the target device identifier and a token associated with the enactment device, and provide the enactment authentication token to the UI gateway, and a proxy server being at the same internet domain as the web server and configured to receive a request to access an enactment session with the web application at the enactment device, the request including the enactment authentication token, the web server is configured to, via the proxy server, create the enactment session between the enactment device and the web application, and the enactment session between the enactment device and the web application mimics an authenticated session between the web application and the target device.

In some embodiments, the web server is further configured to receive a request from the target device to access an authenticated session of the web application, and create the authenticated session between the target device and the web application. In some embodiments, the UI gateway is further configured to detect a request to release access to the authenticated session of the web application for the target device, enable at least one function of the authenticated session of the web application for the target device previously disabled by the UI gateway, and transmit a release access request from the UI gateway to the web server, the web server is further configured to clear the enactment session between the enactment device and the web application and clearing the enactment session includes deleting an access token cookie and a session token cookie.

In some embodiments, the web server, via a web-shell SPA of the web application, is further configured to detect a mouse-out or mouse-over event and transmit the request to release access to the instance of the web application intended for the target device. In some embodiments, the UI gateway is configured to transmit the release access request to an inline frame embedded in the UI gateway that is on the internet domain of the web application. In some embodiments, the web server is further configured to disable at least one function of the authenticated session between the target device and the web application.

In some embodiments, the at least one function includes a cart function for the web application. In some embodiments, the web application includes a plurality of single page applications hosted by the web server at the same internet domain as the proxy server. In some embodiments, the web server is configured to restrict requests for session creation of the web application from servers operating on a different internet domain, and the UI gateway is a server that operates on a different internet domain than the web server. In some embodiments, the enactment authentication token includes one or more of: a unique identifier of the enactment device, a permission identifier, and the target device identifier. In some embodiments, the web server is further configured to, via the proxy server, set an access token cookie and a session cookie specific to the enactment device.

In some embodiments there is a system including a UI gateway configured to receive a request from an enactment device to mimic an authenticated session between a web application hosted by a web server and a target device, wherein the UI gateway includes an inline frame embedding a web-shell single-page application (SPA) therein, wherein the web-shell SPA is configured to connect the UI gateway to the web server, and wherein the UI gateway operates on a different internet domain than the web-shell SPA and the web server and wherein the web server restricts direct access to the web application for the UI gateway, the web server is configured to transmit to the inline frame a respective web page of the web application, the UI gateway is configured to cause the enactment device to display the web application including the inline frame embedding the web-shell single-page application and an inline frame hosting the respective web page of the web application, and the UI gateway is configured to detect a user action at the enactment device at the inline frame hosting the web page of the web application, and in response to detection of the user action, modify a connection of the target device and the enactment device to the web application.

In some embodiments, the web-shell single-page application includes an inline frame including web pages of the web application. In some embodiments, the UI gateway is further configured to connect the enactment device to a session with the web application that mimics an authentication of the target device, and when connecting the enactment device to the session of the web application the UI gateway is configured to create a session token or refresh an already-created session token for the enactment device. In some embodiments, the UI gateway is further configured to disconnect the enactment device from the session with the web application that mimics authentication of the target device, connect the target device to a session with the web application, and connect the enactment device to a session with the web application that mimics authentication of a second target device.

In some embodiments, the UI gateway is further configured to disconnect the enactment device from a session of the web application that mimics an authentication of the target device, connect the target device to another session of the web application, and create or refresh already created session tokens for the target device. In some embodiments, the user action is a mouse-over action at a perimeter of the inline frame configured to host the web page of the web application. In some embodiments, the user action is a mouse-out action outside of a perimeter of the inline frame configured to host the web page of the web application. In some embodiments, the UI gateway is further configured to detect and modify one or more elements of the respective web page at the web-shell SPA and display the modified one or more elements of the respective web page at the enactment device.

In another embodiment there is a system including a UI gateway configured to receive a request from an enactment device to mimic an authenticated session between a web application and a target device, the web application being hosted by a web server, wherein the UI gateway includes an inline frame embedding a web-shell single-page application (SPA) therein, wherein the web-shell SPA is configured to connect the UI gateway to the web server, wherein the UI gateway operates on a different internet domain than the web-shell SPA and the web server and wherein the web server restricts direct access to the web application for the UI gateway, the web server is configured to transmit to the inline frame a single page application of the web application, the web application including a plurality of single page applications hosted at the same internet domain, the web-shell SPA is configured to modify the single page application of the web application, and the UI gateway is configured to display at the enactment device in communication with the UI gateway, the modified single page application of web application at the inline frame.

### BRIEF DESCRIPTION OF THE DRAWINGS

The following detailed description of embodiments of the system and method, will be better understood when read in conjunction with the appended drawings of exemplary embodiments. It should be understood, however, that the invention is not limited to the precise arrangements and instrumentalities shown.

In the drawings:

FIG. 1 is a block diagram illustrating an implementation of a system for enacting authorized mimicking of authenticated sessions in web-based applications in accordance with an exemplary embodiment of the present disclosure;

FIG. 2 is a block diagram illustrating an implementation of the UI gateway of the system of FIG. 1;

FIG. 3 illustrates an exemplary user interface of a session between a web application a target device of the system of FIG. 1;

FIG. 4 illustrates an exemplary user interface displayed at an enactment device of an enactment session mimicking an authenticated session between a first target device and the web application;

FIG. 5A illustrates an exemplary user interface displayed at an enactment device of enactment session mimicking an authenticated session of a first target device and the web application;

FIG. 5B illustrates an exemplary user interface displayed at an enactment device of an enactment session mimicking an authenticated session between a second target device and the web application;

FIG. 6 is a flowchart illustrating mimicking an authenticated session of a web application via the system of FIG. 1 and in accordance with an exemplary embodiment of the present disclosure;

FIG. 7 is a flowchart illustrating releasing access to a web application via the system of FIG. 1 and in accordance with an exemplary embodiment of the present disclosure;

FIG. 8 is a flowchart illustrating a method in accordance with an exemplary embodiment of the present disclosure; and

FIG. 9 is a flowchart illustrating a method in accordance with an exemplary embodiment of the present disclosure.

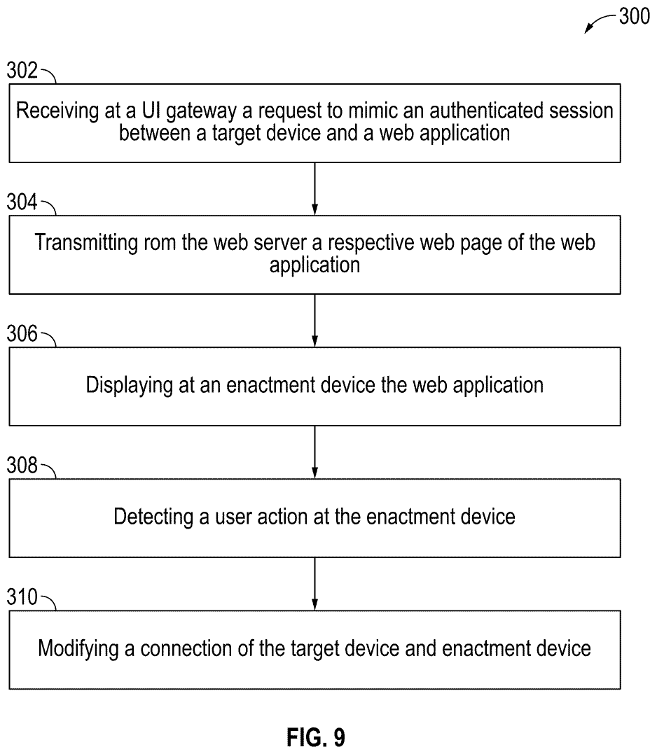

### DETAILED DESCRIPTION

Web-based applications, or web-applications for short, providing a variety of services (e.g., e-commerce, email services, online banking, collaboration tools) often include authenticated accounts (e.g., a user account) for users of the application. The authenticated account provides a unique identifier that allows the user to access and interact with the web-based application. Typically, this includes a user providing credentials (e.g., username, password) to log in to the web-based application. Upon successful log in, an authenticated session between the user's device and the web-application is generated, which allows the user to stay logged in and/or access data privileged only for that user. Providers of the web-based application may wish to imitate or mimic a user's authenticated session in order to assist a user and/or to test functionalities of the web-application. For example, a provider of the web-application may wish to mimic an authenticated session between a user's device and the web-application in order to support the user in accessing and/or interacting with the web-application (e.g., customer support services). However, doing so often requires configuring the web-application for such services, which can be difficult and cumbersome. This problem is exacerbated in instances where functionalities of the web-application are split amongst a plurality of single-page applications (SPA).

Numerous details are described herein in order to provide a thorough understanding of the example embodiments illustrated in the accompanying drawings. However, some embodiments may be practiced without any of the specific details, and the scope of the claims is only limited by those features and aspects specifically recited in the claims. Furthermore, well-known methods, components, and circuits have not be described in exhaustive detail so as not to unnecessarily obscure pertinent aspects of the embodiments described herein.

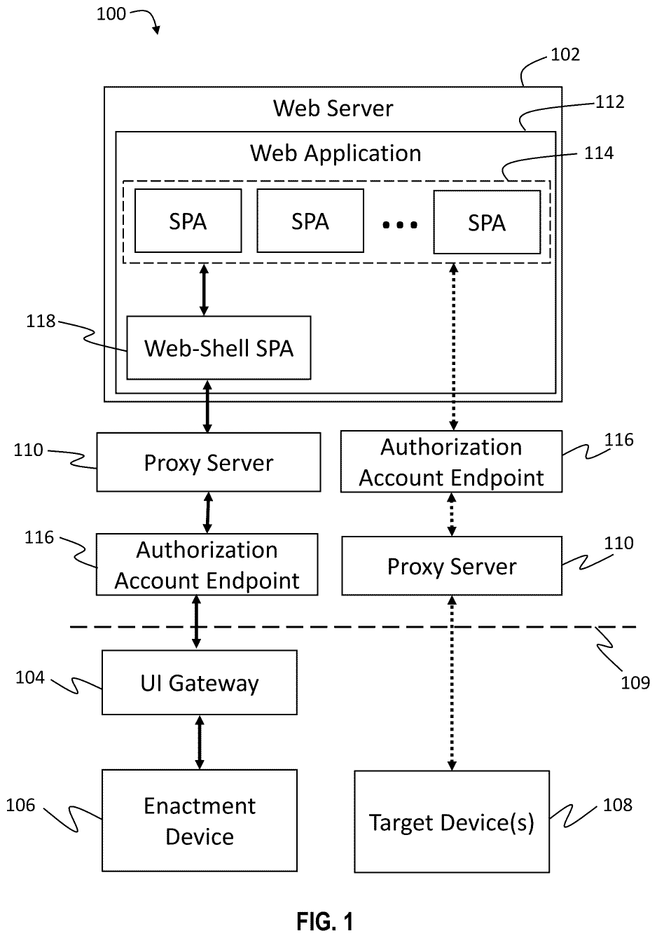

Referring to the drawings in detail, wherein like reference numerals indicate like elements throughout, there is shown in FIGS. 1-5 a system for enacting authorized mimicking of authenticated sessions in web-based applications, and alternatively referred to as system 100 for short, in accordance with an exemplary embodiment of the present disclosure.

In one embodiment, the system 100 includes one or more computers or computing devices having one or more processors and memory (e.g., one or more nonvolatile storage devices). In some embodiments, memory or computer readable storage medium(s) of memory store programs, modules and data structures, or a subset thereof, for a processor to control and run the various systems and methods disclosed herein. In one embodiment, a non-transitory computer readable storage medium having stored thereon computer-executable instructions which, when executed by a processor, performs one or more of any combination of the methods or steps disclosed herein. In some embodiments, one or more of the computers or computing devices (e.g., servers) included in the system 100 may include a collection of networked computing devices, servers and/or processing units in communication with one another. In some embodiments, the functionality of a server may be accessible at another server via one or more application programming interfaces (APIs) and/or networks. For sake of brevity, one or more computers or computing devices included in the system 100 may be referred to as servers.

In some embodiments, one or more elements of the system 100 may be in communication with one another via any suitable type of network, including, but not limited to, individual connections via the Internet, such as cellular or Wi-Fi networks. In some embodiments, the network may connect terminals, services, computing devices, external devices using direct connections, such as, but not limited to, radio frequency identification (RFID), near-field communications (NFC), Bluetooth™, low-energy Bluetooth™, Wi-Fi™, Zigbee™, ambient backscatter communication (ABC) protocols, USB, WAN, or LAN. Because the information transmitted may be personal or confidential, security concerns may dictate one or more of these types of connections, be encrypted or otherwise secured. In some embodiments, one or more security protocols included in web-applications discussed herein incorporate a same-origin browser policies.

Referring to FIG. 1, there is shown a block diagram illustrating an implementation of the system 100. The system 100 may include a web server 102, a user interface (UI) gateway 104, an enactment device 106 and one or more target devices 108. The web server 102 may be in communication with the UI gateway 104, enactment device 106 and target device(s) 108 via a network (e.g., the Internet). In some embodiments, the system 100 includes a proxy server 110 configured to facilitate communications (e.g., requests, responses) between the web server 102 and one or more of the UI gateway 104, enactment device 106 and/or target device(s) 108. In some embodiments, the UI gateway 104 is configured to enable an enactment device 106 to mimic an authenticated session between the web server 102 and one or more target devices 108.

In some embodiments, the web server 102 hosts a web application 112 that is accessible via the internet and viewable by a customer on a respective target device 108. In some embodiments, the web server 102 is in communication with a plurality of target devices 108 and configured to generate and transmit the web application 112 to the plurality of target devices 108. In some embodiments, the web application 112 is configured to facilitate digital transactions between target devices 108 and the web server 102 (e.g., purchases of products by customers via the web application 112). For example, the web application 112 may be an online storefront having a customer facing UI that may be rendered at a target device 108 such that a user of the device 108 may interact with the online storefront to procure good and/or services. For sake of brevity, examples discussed herein of the web application 112 hosted by web server 102 are in relation to an online storefront, however it should be understood that aspects of the present disclosure may be used in conjunction with other types of web applications (e.g., self service applications) such as, but not limited to, online banking, email services, collaboration tools, media platforms, streaming platforms, utility provider platforms, insurance platforms, mortgage platforms, ride sharing applications, online marketplaces, online auctioning platforms, and social media platforms.

In some embodiments, the web application 112 hosted by the web server 102 may include a plurality of single-page applications (SPA) 114. For example, an online storefront hosted by the web server 102 is comprised of a plurality of SPAs. The SPAs comprising the web application 112 hosted by the web server 102 may be configured for specific functionalities of the web application 112. For example, a first SPA may be configured to provide virtual shopping cart management while a second SPA may be configured to provide product browsing.

The web server 102 may be accessible to users at an internet domain. For example, a user may access the web application 112 of the web server 102 may directing a web browser to the internet domain of the web server 102. In some embodiments, the web server 102 is accessible at an internet domain that is different from an internet domain of the UI gateway 104, as discussed in more detail below. In some embodiments, the SPAs that comprise the web application 112 may each be at the same internet domain as the web application 112 of the web server 102. For example, the SPAs may be at subdirectories, subdomains or part of a frontend architecture of the internet domain associated with the web application 112 hosted by the web server 102. In some embodiments, there is a firewall 109 between the UI gateway 104 and the web server 102 and/or proxy server 110. In some embodiments, the firewall 109 is configured to monitor and control incoming and outgoing network traffic at the internet domain of the web server 102 based on predetermined security rules.

In some embodiments, the firewall 109 is a software firewall installed on the proxy server 110 and/or web server 102.

In some embodiments, users may access and interact with the web application 112 of the web server 102 via an authenticated session between the web application 112 and a target device 108. For example, a customer of the online storefront hosted by the web server 102 establishes an authenticated session with the online storefront by inputting their login credentials. The customer's login credentials may take the form of, for example, a username and password which are input at a target device 108 displaying the online storefront. In response to the login credentials being valid, the web server 102 may be configured to establish an authenticated session between the target device 108 and the web server 102. The customer may, while the session remains active, interact with the web application 112 via the target device 108 to access personalized features such as viewing order history, managing account settings, and making purchases. An authenticated session between the target device 108 and web application 112 of the web server 102 may begin when the customer login credentials are validated by the web server 102 and end when the web server 102 receives a logout request (e.g., the customer selects a logout option via target device 108).

A session in relation to the web application 112 hosted by the web server 102 may refer to a temporary interaction between the web server 012 and a user device (e.g., enactment device 106, target device 108) displaying the web application 112 and/or a SPA 114 of the web application 112.

In some embodiments, the system 100 includes a company-specific authorization account endpoint 116 also referred to as an authorization account endpoint 116 herein. The authorization account endpoint 116 may be configured to verify user credentials (e.g., verify user authentication), generate access tokens, and/or manage sessions between user devices and the web application 112 112. In some embodiments, the authorization account endpoint 116 is included in the web server 102. For example, the authorization account endpoint 116 is a specific uniform resource locator (URL), uniform resource identifier (URI), or an application programming interface (API) endpoint of the web application 112 hosted by the web server 102.

In some embodiments, the authorization account endpoint 116 is configured to receive login request from a user device (e.g., target device 108, enactment device 106) and verify credentials associated with the login request. For example, the authorization account endpoint 116 receives credentials (e.g., username, password) associated with a login request and determines whether the credentials are valid. In response to determining that the credentials included in a login request are valid the authorization account endpoint 116 may be configured to generate an access token and transmit the access token back to the user device. For example, the authorization account endpoint 116 validates login credentials, generates an access token and transmits the access token back to the user device that requested the login. An access token may be data that acts a credential used to authenticate and authorize a user device to access resources of the web application 112.

In some embodiments, the authorization account endpoint 116 is configured to transmit access tokens to the target device(s) 108 and/or enactment device 106. In other embodiments, the authorization account endpoint 116 is specific to the enactment device 106 and the system 100 includes a separate endpoint for target device(s) 108. For example, the web server 102 may include an endpoint that is generally the same as endpoint 116 but is exclusive to target device(s) 108.

Further to this example, the endpoint for target device(s) 108 may be configured to handle generally the same functionality as the endpoint 116 (e.g., verify user credentials, generate access tokens, manage sessions).

The proxy server 110 may be configured to manage and distribute network traffic, handle load balancing, and/or handle security for the web server 102. In some embodiments, the proxy server 110 is a reverse proxy configured to act as an intermediary between user devices (e.g., enactment device 106, target device 108) and the web server 102. For example, the proxy server 110 may be configured to pass requests from enactment device 106, target device 108, and/or UI gateway 104 to the web server 102 and relay responses from the web server 102. The proxy server 110 may be configured to mitigate denial of service (DOS) attacks directed at the web server 102. For example, the proxy server 110 may be configured to filter incoming network traffic to the web server 102, set limits on the number of requests within a time frame, detect anomalous traffic patterns, maintain an IP blacklist of known malicious IP addresses, and/or throttle response times for some network traffic.

In some embodiments, the proxy server 110 is a software application installed on the web server 102. For example, the proxy server 110 may be the high availability proxy that is installed on the web server 102. In other embodiments, the proxy server may be a proxy server that is separate from the web server 102 and is configured to process requests to and from the web server 102. In some embodiments, the proxy server 110 is at the same internet domain as the web server 102.

The web server 102 may be configured to generate sessions between the web application 112 and one or more of the enactment device 106 and target device(s) 108. For example, the web server 102 may be configured to receive a request for a session with the web application 112 from an enactment device 106, via the UI gateway 104, and generate a session of the web application. In some embodiments, the proxy server 110 is configured to route a request for a session with the web application 112 from target device(s) 108 to the web server 102. In other embodiments, the web server 102 is configured to receive requests for a session with the web application 112 directly from target device(s) without the proxy server 110 acting as an intermediary.

In some embodiments, the web server 102 is configured to determine whether the user device requesting a session with the web application has a corresponding access token. For example, the web server 102 receives a request for a session from the enactment device 106 and determines whether the enactment device 106 has stored thereon an access token received from the authorization account endpoint 116. Further to this example, in response to determining that the enactment device 106 does include the access token the web server 102 is configured to generate an authenticated session between the enactment device 106 and web application 112 as discussed in more detail below.

Still referring to FIG. 1, the UI gateway 104 may be configured to enable a user of the enactment device 106 to mimic an authenticated account session between the web application 112 and a target device 108. The UI gateway 104 may be at an internet domain that is different from the web server 102. For example, the web server 102 may be at a first internet domain and the UI gateway may be at a second internet domain that is different from the first internet domain.

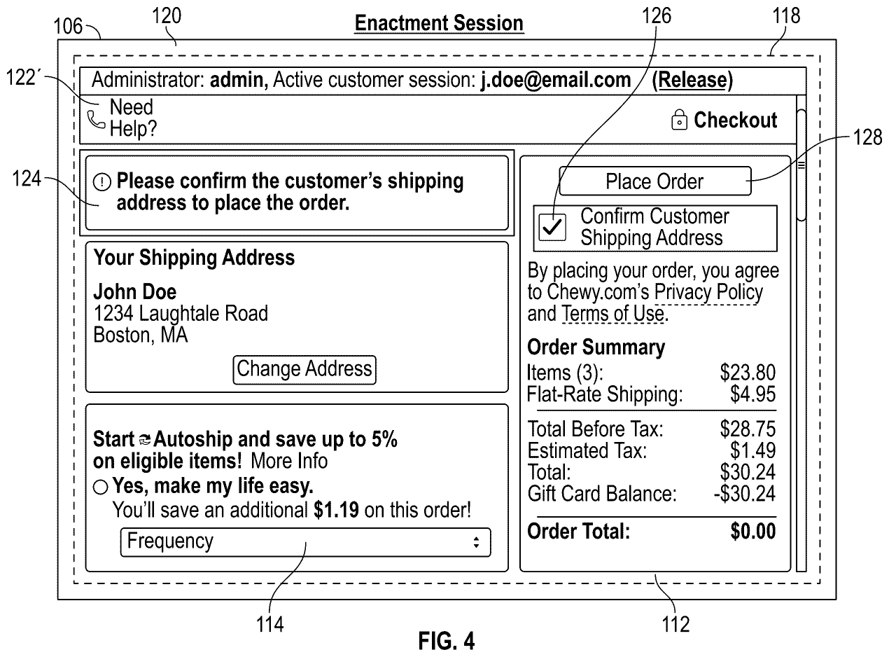

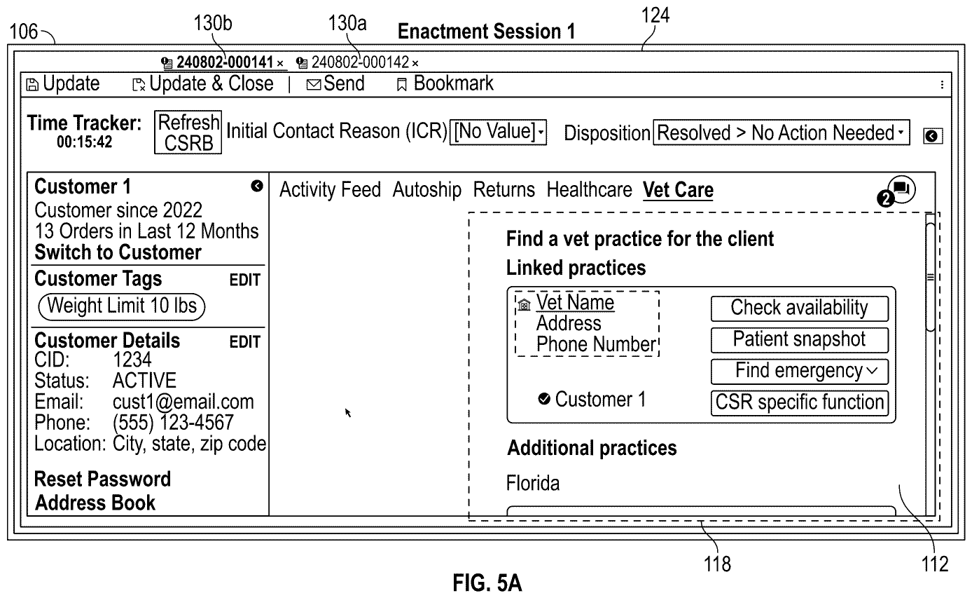

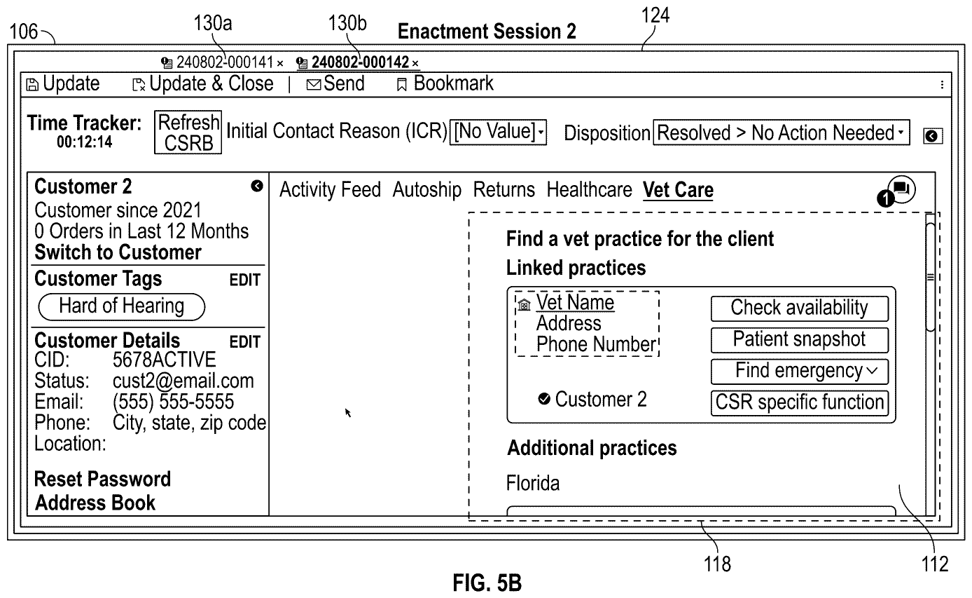

The UI gateway 104 may be configured to generate an enactment UI (e.g., enactment UI 120 illustrated in FIGS. 4 and 5A-5B) displayed at an enactment device 106 to enable a user to interact with an authenticated session of the web application 112 while mimicking a target device 108. In some embodiments, the UI gateway 104 is configured to receive a request from the enactment device 106 to access the enactment UI and cause the enactment device 106 to render the enactment UI thereon. In some embodiments, the UI gateway 104 is configured to enable a user at the enactment device 106 to interact with the web application 112 of the web server 102 via the enactment UI, as discussed in more detail below. The enactment UI 120 hosted by the UI gateway 104 may be at a different internet domain than the web application 112.

The web server 102 may include a web-shell SPA 118 configured to enable the UI gateway 104 to access one or more functionalities of the web server 102. In some embodiments, the web-shell SPA 118 may be a website file or application executable at a user device that is configured to act like a website. The web server 102 may be configured to generate a web-shell SPA 118 and transmit the web-shell SPA 118 to UI gateway 104. The web-shell SPA 118 may be on the same internet domain as the web server 102 and/or proxy server 110. For example, the web-shell SPA 118 and web application 112 may be at the same internet domain. The web-shell SPA 118 may be configured to enable a user of the enactment device 106 to interact with the web application 112 when mimicking an authenticated session.

In FIG. 1, the double headed arrows may represent respective communications paths between the web server 102 and the enactment device 106 and target device 108. The solid line double headed arrows may represent a communication pathway between the enactment device 106 and web server 102. The dotted line double headed arrows may represent a communication pathway between the target device 108 and web server 102. Although two instances of proxy server 110 and authorization account endpoint 116 are illustrated in FIG. 1 it should be understood that each instance may be specific to the communications pathways for the enactment device 106 and target device 108 respectively. For example, a request to access the web application from the target device 108 may pass from the proxy server 110 to the authorization account endpoint 116 and to the web server 102. Further to this example, a request for an enactment session from the enactment device 106 may pass from the UI gateway 104, to the authorization account endpoint 116, to the proxy server 110 and to the web server 102.

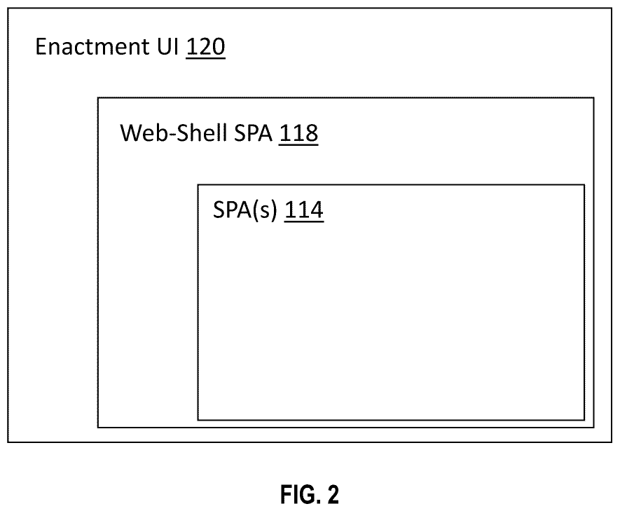

Referring to FIGS. 1-2, in some embodiments, the web-shell SPA 118 is configured to provide access to the web application 112 at the UI gateway 104 via the enactment UI 120. As illustrated in FIG. 2, the web-shell SPA 118 may be embedded within the enactment UI 120. The web-shell SPA 118 may embed one of more of SPAs 114, of the web application 112, therein. The enactment UI 120, as discussed above, may be a user interface hosted by the UI gateway 104 and/or be at the same internet domain as the UI gateway 104. In some embodiments, the web-shell SPA 118 is embedded within an inline frame, also referred to as an iFrame, of the enactment UI 120. For example, content of the web-shell SPA 118 may be embedded within an inline frame included in an enactment UI 120 hosted at the UI gateway 104. In some embodiments, the web-shell SPA 118 includes an inline frame embedded therein and configured to embed at least a portion of the web application 112 hosted by the web server therein. For example, and as discussed in more detail below, the inline frame embedded in the web-shell SPA 118 embeds content from one or more of the SPAs 114 that comprise the web application 112. In some embodiments, an inline frame embeds the web-shell SPA 118 within the UI gateway 104 and another inline frame embeds the content of one or more SPAs 114 of the web-application 112 within the web-shell SPA 118. In some embodiments, the web-shell SPA 118 is configured to embed each SPA 114 of the web application 112.

In some systems, security protocols and/or policies, such as same-origin browser policies, generally restrict or isolate the content of web-applications hosted at separate domains. For example, in some systems the content from one web-application embedded in another via an iFrame is isolated from the web-application within which the iFrame is embedded. Accordingly, in some systems, executable scripts, executable programs, presentation styles (e.g., CSS styles), and the like are isolated between web-applications hosted at separate domains. In some embodiments, the systems and methods described herein enable the enactment UI 120 to safely access restricted resources of the web application 112 without requiring each SPA 114 comprising the web application 112 to whitelist the enactment UI 120 and/or include custom configurations. In some embodiments, the systems and methods described herein enable the enactment UI 120 to access resources of the web application according to a cross-origin resource sharing (CORS) policy.

In some embodiments, the web server 102 is configured to restrict resources of the web application 112 for servers operating on a different internet domain than the web server 102. For example, the web server 102 is configured to restrict access to content of the web application 112 at servers that lack one or more predetermined permissions and/or operate on a different internet domain. As discussed above, the UI gateway 104 may be a server that operates on a different internet domain than the web server 102. In some embodiments, the web-shell SPA 118 is configured to enable the UI gateway 104 to access content/functionalities of the web application 112 that would otherwise be restricted to servers operating at an internet domain different than the web server 102.

The web-shell SPA 118 of the present disclosure may be configured to modify existing functionalities of the web-application 112 and/or add functionalities to the web-application 112 regardless of the UI gateway 104 and web server 102 being on separate internet domains. In some embodiments, the web-shell SPA 118 is configured to enable cross-domain transfer of data with the UI gateway 104 in accordance with one or more security protocols set at the web server 102. Cross-domain security permissions may be established between the web-shell SPA 118 and the UI gateway 104 such that the UI gateway 104 may be allowed to access a modified session of the web application 112 in which one or more functionalities of the web application 112 have been modified and/or in which one or more functionalities have been added.

As discussed above, the web-shell SPA 118 may include an inline frame embedded therein that is configured to access one or more of the SPAs 114 that comprise the web-application 112. The web-shell SPA 118 and the SPAs 114 of the web-application 112 may be on the same internet domain such that data may be transferred between each. In some embodiments, the inline frame embedded within the web-shell SPA 118 embeds therein each of the SPAs 114 that comprise the web application 112 such that the entire web application 112 may be accessible to the web-shell SPA 118. As discussed above, the web-shell SPA 118 and UI gateway 104 may have cross-domain permissions such that data from the UI gateway 104 may be transmitted to the SPAs 114 of the web-application 112 via the web-shell SPA 118.

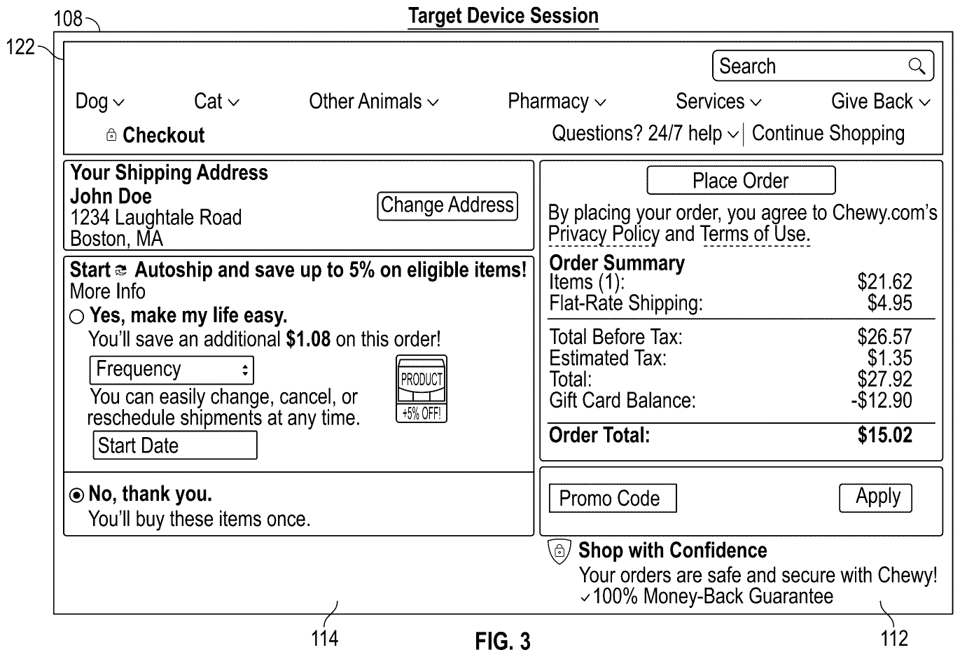

Referring to FIGS. 3-4, in some embodiments, the web-shell SPA 118 is configured to modify the web application 112 for display at the enactment UI 120. The web-shell SPA 118 may be configured to inject computer executable code via API or service bridge(s) (e.g., JavaScript bridges) into the web application 112. In some embodiments, injecting computer executable code from the web-shell SPA 118 into the web application 112 may enable the appearance, content and/or functionalities of the web application 112 to be dynamically altered. FIG. 3 illustrates a session between a target device 108 (e.g., a customer device) and the web-application 112. FIG. 4 illustrates an enactment session between an enactment device 108 (e.g., customer service device) and the web application 112 that mimics the authenticated session illustrated in FIG. 3.

In some embodiments, the web-shell SPA 118 is configured to modify the presentation and/or layout of the web application 112. In some embodiments, the web-shell SPA 118 is configured to cause the web-shell SPA 118 to edit a cascading style sheet (CSS) applied to a SPA 114 of the web application 112 such that the appearance and/or position of one or more HTML elements included therein are modified. For example, the web application 112 in FIG. 3 includes a banner 122 displaying a search bar, a plurality of drop-down menus, text and/or hyperlinks. Further to this example, in FIG. 4 the web application 114 includes a modified banner 122′ in which the search bar, some text, and the drop-down menus have been removed, some of the text has been moved in position and the banner 122′ includes a header displaying the email address (e.g., j. doe@email. com) associated with the enactment session.

In some embodiments, the web-shell SPA 118 is configured to add content to the web application 112. The web-shell SPA 118 may be configured to add one or more HTML elements to a SPA 114. For example, in FIG. 4 the web application 112 includes a section 124 (e.g., a <div> element) with a notice to confirm the customer's shipping address, which is not displayed in the web application 112 illustrated in FIG. 3. In some embodiments, the web-shell SPA 118 is configured to modify a script of the web-application 112. The web-shell SPA 118 may be configured to modify an existing script associated with the web application 112 and that is executed by the web server 102.

For example, the in FIG. 4 the web application 112 includes a selection box 126 not included in web application 112 illustrated in FIG. 3 that must be selected in order for the ‘place order’ button 128 to operate.

The web-shell SPA 118 may be configured to enable the system 100 to inject computer executable code into a plurality of the SPAs 114 comprising the web application 112 without the need to modify the individual SPAs 114. In some embodiments, the computer executable code injected by the web-shell SPA 118 may correspond to one or more desired user specific functionalities. For example, and in the context of the web application 112 being an online storefront, it may be desirable to add functionalities to the web application 112 for customer support representatives that are not available to customers of the web application. As discussed above, the web application 112 may be comprised of a plurality of SPAs 114 each having underlying computer executable code (e.g., HTML code, CSS code). In some web application systems implementing a plurality of SPAs, user specific functionalities may be required to be incorporated into the underlying computer executable code of each SPA. For example, the underlying computer executable code of each SPA in a web application system would need to be modified in order to provide user specific functionalities. However, the web-shell SPA 118 of the present disclosure may enable user specific functionalities by events passed by the UI gateway 104 and implemented in any SPA 114 of the web application 112 without the need to add said functionalities to the underlying code of each SPA 114.

In some embodiments, the web-shell SPA 118 may be configured to cause the content and/or functionalities of the web application to be modified, removed, or added at a session level. For example, and as illustrated in FIGS. 3-4, content of the web application 112 is modified within the enactment session between the enactment device 106 and the web application 112 via the web-shell SPA 118. Further to this example, the same content of the web application 112 remains unchanged, or unmodified, within the session between a target device 108 and the web application 112. In some embodiments, the system 100 is configured to prevent a target device 108 from accessing a modified session of the web-application 112 via web-shell SPA 118. In some embodiments, the web server 102 and/or proxy server 110 are configured to prevent the target device 108 from accessing the web-shell SPA 118. In some embodiments, the web server 102 and/or proxy server 110 are configured to prevent the web-shell SPA 118 from modifying the web application 112 in an instance in which a session between the web-shell SPA 118 and target device 108 is established.

It should be understood that the modifications illustrated in FIG. 4 are non-limiting examples and that the web-shell SPA 118 may be configured to cause the content, presentation and/or functionalities of the web application 112 to be modified in a plurality of different ways. In some embodiments, the system 100 is configured to enable modification of the web application 112 at an enactment device 106 to aid a user of the enactment device (e.g., a customer service representative). For sake of brevity not every modification of the web application 112 illustrated in FIG. 4 in comparison to FIG. 3 have been described.

Referring back to FIGS. 1-2, and as discussed above, the system 100 may be configured to mimic an authenticated session between a target device 108 and the web application 112 at the enactment device 106. The UI gateway 104 may be configured to receive a request from an enactment device 106 to mimic an authenticated session between a target device 108 and the web application 112. The UI gateway 104 may be configured to, in response to receiving the request from the enactment device 106, transmit a request to the authorization account endpoint 116 for an enactment authentication token. In some embodiments, the request for the enactment authentication token includes a target device identifier (e.g., a customer id). For example, the request for the enactment authentication token includes a unique identifier that is specific to the target device 108 which the enactment device 106 requested to mimic. In some embodiments, the request for the enactment authentication token may also include a token associated with the enactment device 106. For example, the UI gateway 104 is configured to validate login credentials from the enactment device 106 and generate a corresponding access token associated with an authenticated session between the enactment UI 120 and enactment device 106. The token associated with the enactment device 106 may be stored on the enactment device 106 (e.g., as a cookie).

Tokens as discussed herein may refer to data that is configured to serve as credentials that authenticate a user device (e.g., target device 108, enactment device 106) and/or authorize access to resources of a web application (e.g., web application 112, enactment UI 120). Tokens may be stored at the respective user devices at which they are received within local storage, session storage or as cookies. Tokens may be encoded or encrypted in accordance with any desired security protocols.

In some embodiments, the authorization account endpoint 116 is configured to receive the target device identifier associated with the target device 108 and the token associated with the enactment device 106 and generate the enactment authentication token. The enactment authentication token may be configured to enable the enactment device 106 to be authenticated with the web application 112 as the target device 108. The authorization account endpoint 116 may be configured to transmit the enactment authentication token to the UI gateway 104. In some embodiments, the enactment authentication token includes an access token and an identifier token. The access token may include data corresponding to login credentials associated with the target device 108. For example, the access token for the enactment device 106 may include one or more of: a unique identifier of the enactment device, a permission identifier, and the target device identifier. The identifier token may include data associated with the enactment device 106 that identifies a user of the enactment device 106.

In some embodiments, the UI gateway 104 is configured to transmit to the web server 102 a request to access an enactment session with the web application 112. For example, the UI gateway 104 is configured to, in response to receiving the enactment authentication token, transmit a request to the proxy server 110 to access an enactment session with the web application 112 that mimics the target device 108. In some embodiments, the UI gateway 104 is configured to transmit the enactment authentication token to the proxy server 110 in the request to access the enactment session.

The web server 102 may be configured to create the enactment session between the enactment device 106 and the web application 112. In some embodiments, the web server 102 is configured to, via the proxy server 110, create the enactment session in response to receiving and validating the enactment authentication token from the UI gateway 104. The enactment session between the enactment device 106 and web application 112 may mimic an authenticated session between the web application 112 and the target device 108. For example, in FIG. 4 an enactment session of the web application 112 rendered at the enactment device 106 via web-shell SPA 118 is shown. In FIG. 4, the enactment session mimics and authenticated session between the web application 112 and a target device 108. Mimicking the target device 108 within an enactment session may include authenticating with the web application 112 using the authentication credentials associated with the target device 108. For example, within an enactment session the enactment device 106 is authenticated with the web application 112 using login credentials specific to the target device 108.

In some embodiments, the web server 102 is configured to set one or more enactment device 106 specific permissions within an enactment session. The web server 102 may be configured to receive the enactment authentication token and set one or more enactment device 106 specific permissions within the generated enactment session. As discussed above, the enactment authentication token may include an access token including login credentials associated with the target device 108 and at least one ID token that identifies the enactment device 106. In response to receiving the access token the web server 102 may be configured to, via proxy server 110, authenticate the enactment device 106 as the target device 108 within the enactment session of the web application 112. In response to receiving the ID token the web server 102 may be configured to, via the proxy server 110, set one or more permissions exclusive to the enactment device 106 within the enactment session of the web application 112. In some embodiments, creating the enactment session includes setting an access token cookie and a session cookie specific to the enactment device 106. For example, the web server 102 is configured to, via the proxy server 110, set an access token cookie and session cookie at the enactment device 106.

In some embodiments, the system 100 is configured to restrict functionality of the web application 112 at a target device 108 while there is an active enactment session at the enactment device 106. The web server 102 may be configured to disable at least one function of an authenticated session between a target device 108 and the web application 112. For example, in response to an enactment session between the web application 112 and enactment device 106 being active, the web server 102 is configured to cause the web server 102 to disable at least one function of the web application 112 within a session at a target device 106.

In some embodiments, the disabled function is dependent upon the web application 112. In instances where the web application is an online storefront the disabled function may be a cart function (e.g., a virtual shopping cart function). For example, online retail storefronts typically include a virtual shopping cart that enables users to select and store items they wish to purchase from the online retail storefront. However, while an enactment session is active it may not be desirable to allow both the target device 108 and an enactment device 106 to make edits to a virtual shopping cart. The web server 102 may be configured to disable a cart function for active sessions of the web application 112 and a target device 108 while an enactment session mimicking the target device 108 is active. The web server 102 may be configured to disable a plurality of functions of the web application 112 in response to an enactment session being active.

It should be understood that the online retail storefront and cart function discussed above is one example of web application 112 and a function thereof that the web server 102 may be configured to disable. In instances where the web application 112 is an online banking service, the web server 102 may be configured to disable monetary transactions (e.g., payments, transfer of funds) within an authenticated session between a target device 108 and the web application 112. The above examples are non-limiting and are for purposes of illustrating aspects of the present disclosure. It should be understood that the web server 102 may be configured to disable any number and type of functions of a web application 112 in response to an active enactment session.

In some embodiments, the web server 102 is configured to disable a function of the web application 112 for the enactment session. For example, in an instance where the web application 112 is an online storefront, the web server 102 may be configured to disable the input of payment information within the enactment session. In some embodiments, the web server 102 is configured to modify functionality of the web application 112 based on session cookie data set for the enactment session.

In some embodiments, the web server 102 is configured to monitor activity within an enactment session, via the web-shell SPA 118, and generate corresponding monitoring data. The web-shell SPA 118 may be configured to generate monitoring data based on detecting clicks and/or other inputs at an enactment device 106 that is part of the enactment session. For example, the web-shell SPA 118 may be configured to generate clickstream data in response to each click input, page navigation, and/or interaction of the enactment device 106 during an enactment session. In some embodiments, the web-shell SPA 118 is configured to continuously monitor activity within an enactment session and automatically generate monitoring data. The web server 102 may be configured to automatically transmit the monitoring data to the UI gateway 104 for analytics and/or updates to the enactment UI 124. The web-shell SPA 118 may be configured to transmit generated monitoring data (e.g., clickstream data) to the UI gateway 104. As discussed above, the web-shell SPA 118 and UI gateway 104 may have cross-domain message exchanging permissions set such that data may be transmitted between the two. In some embodiments, the web-shell SPA 118 is configured to transmit continuous clickstream data to the UI gateway 104.

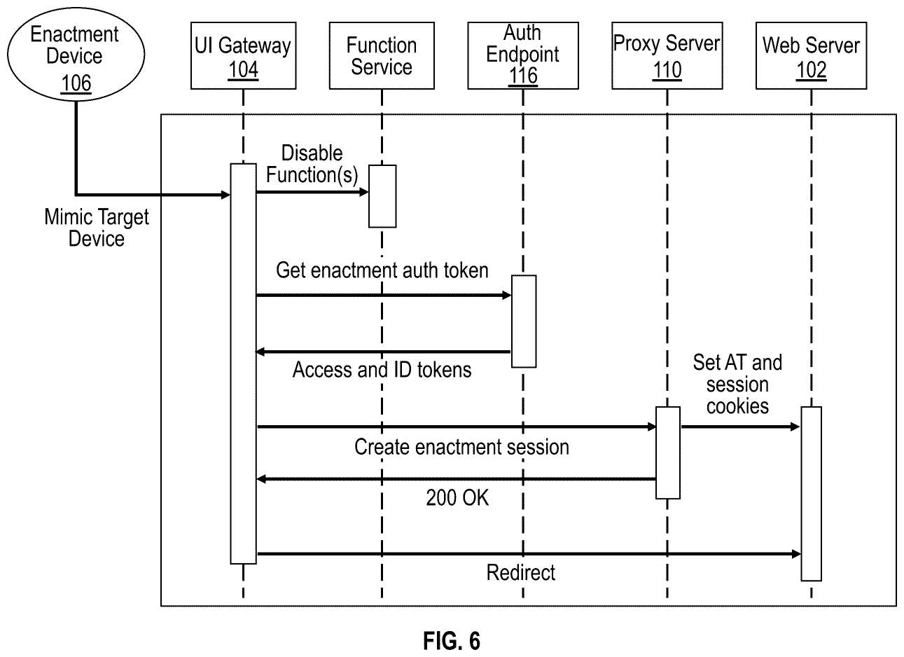

Referring to FIG. 6 there is shown a flowchart illustrating the mimicking of an authenticated session of the web application 112 via system 100. In some embodiments, the UI gateway 104 receives a request from the enactment device 106 to mimic a target device 108. The UI gateway 104 in response to receiving the request may be configured to cause one or more function of the web application 112 to be disabled for the corresponding target device 108. For example, in response to the request to the UI gateway 104, communications may be passed to the web server 102 that causes the web server 102 to disable a function of the web application 112 as discussed above. In some embodiments, the UI gateway 104 transmits the request to disable a function of the web application to service or endpoint (e.g., function service in FIG. 6) via a service-to-service API call. The respective function control may be a module, program, or programming interface (e.g., API) that is configured to control operation of and/or access to the function that is to be disabled. For example, in the context of disabling a cart function, as discussed above, the UI gateway 104 is configured to transmit a disable function request to the API that controls cart functionality at the web application 112.

In some embodiments, in response to receiving the request from the enactment device 106 the UI gateway 104 is configured to transmit a request for the enactment authentication token to the authorization account endpoint 116. The authorization account endpoint 116 may be configured to receive the request for the enactment authentication token and transmit access and ID tokens to the UI gateway 104. For example, in response to validating the enactment authentication token request the authorization account endpoint 116 may generate the enactment authentication token, which may include access and ID tokens, and transmit the token(s) to the UI gateway 104. The token(s) transmitted to the UI gateway 104 from the authorization account endpoint 116 may include data (e.g., unique identifiers, permissions) that enables the enactment device 106 to mimic and/or modify an authenticated session of the web application 112 and target device 108.

In some embodiments, in response to receiving the request from the enactment device 106, the UI gateway 104 is configured to transmit a request to the proxy server 110 to create an enactment session. The UI gateway 104 may be configured to transmit the enactment authentication token to the proxy server 110 with the request to create an enactment session. In some embodiments, the proxy server 110 is configured to validate the request to create the enactment session via enactment authentication token and set one or more of an access token cookie and session cookie. In some embodiments, the proxy server 110 is configured to set the access token and session cookie at the enactment device 106 and/or web server 102. In response to setting the access token and session token cookies the proxy server 110 may be configured to transmit a response to the UI gateway 104 indicating the cookies were set (e.g., a 200OK response code).

In some embodiments, the UI gateway 104 is configured to redirect the enactment device 106 to the web server 102. The web server 102 may be configured to, via proxy server 110, transmit the web-shell SPA 118 to the enactment UI 120 hosted by the UI gateway 104. The web-shell SPA 118 may be configured to display content of the web application 112, as discussed above.

Referring back to FIGS. 1-2, in some embodiments, the web server 102 is configured to determine session activity within an enactment session and, based on the session activity, release access to an authenticated session of the web application 112 for a target device 108. The web server 102 may be configured to determine if an enactment session at an enactment device 106 is inactive and automatically release access to an authenticated session of the web application 112 at a target device 108. In some embodiments, the web server 102 is configured to detect a request to release access to the authenticated session of the web application 112 for the target device 108. In some embodiments, the request to release access is an event within the web-shell SPA 118 detected by the web server 102. The UI gateway 104 may be configured to monitor whether a cursor element (e.g., a mouse) is within the bounds of the web-shell SPA 118 and generate the release access request.

In some embodiments, the UI gateway 104 is configured detect a mouse-out or mouse-over event at the web-shell SPA 118. For example, the UI gateway 104 is configured to detect a mouse-out event indicating that the cursor has moved outside of the bounds of the web-shell SPA 118 embedding an active enactment session of the web application 112. In response to detecting the mouse-out event the UI gateway 104 may be configured to associate the mouse-out event with a request to release access to an authenticated session of the web application 112 for the target device 108 and transmit the request to the web server 102. It should be understood that the UI gateway 104 may be configured to detect events other than a mouse-out and mouse-over event and associate the detected events with a request to release access to an authenticated session for a target device 108.

The web server 102 may be configured to enable at least one function of the authenticated session of the web application 112 for the target device 108 that was previously disabled by the UI gateway 104. As discussed above, the web server 102 may be configured to disable at least one function of the web application 112 for an authenticated session at a target device 108 in response to an active enactment session. In response to detecting the request to release access to the authenticated session for the target device 108, the web server 102 may be configured to cause the previously disabled functionality to be enabled. For example, if the web server 102 caused a cart function to be disabled at the target device 108 the UI gateway 104 may cause the cart function to be enabled at the target device 108.

The UI gateway 104 may be configured to transmit a release access request to the web server 102. In some embodiments, the release access request causes the at least one function of the authenticated session of the web application 112 for the target device 108 that was previously disabled to be enabled. For example, the web server 102 is configured to receive the release access request and cause the previously disabled function(s) to be enabled at an authenticated session of the web application 112 at the target device 108. In some embodiments, the UI gateway 104 is configured to transmit the release access request to the web server 102 by transmitting the request to the inline frame embedded in the UI gateway 104 via web-shell SPA 118.

In some embodiments, the web server 102 is configured to clear the enactment session between the enactment device 106 and the web application 112. For example, the web server 102 is configured to receive the release access request from the UI gateway 104 and cause an active enactment session at the enactment device 106 to become inactive. In some embodiments, clearing the enactment session includes deleting an access token cookie and a session token cookie. For example, the web server 102 is configured to, in response to receiving the release access request, cause an access token cookie and/or a session token cookie stored on the enactment device 106 to be deleted therefrom.

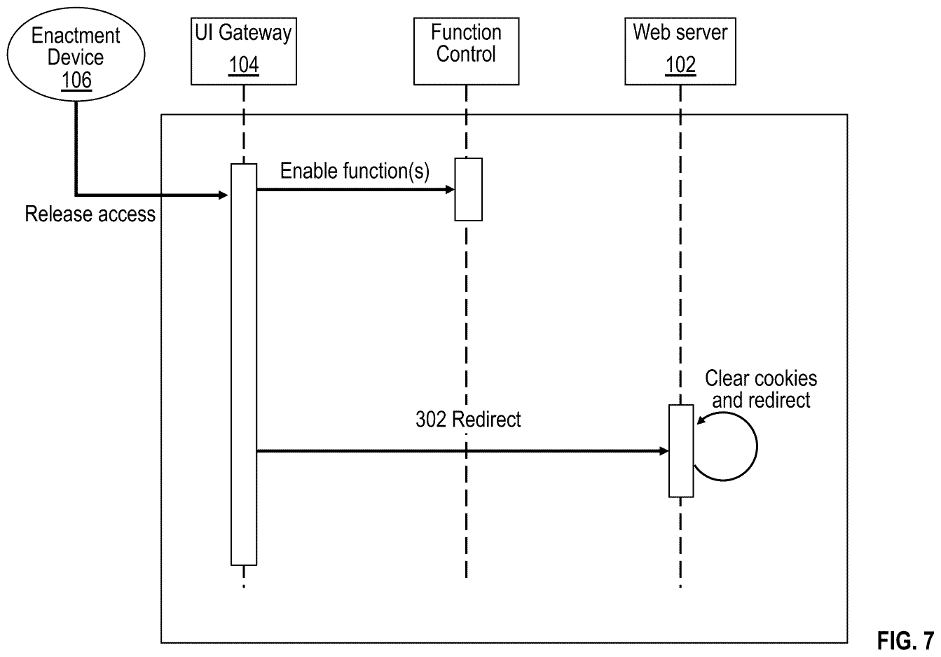

Referring to FIG. 7 there is shown a flowchart illustrating a release access request via the system 100 of the present disclosure. The enactment device 106 may transmit a release access request to the UI gateway 104. The release access request may be a request to release access to an enactment session with the web application 112 that mimics a target device 108. The release access request, as discussed above, may be detected by the UI gateway 104 as, for example, a mouse-out or mouse-over event. In response to receiving the release access request, the UI gateway 104 may be configured to transmit a request to enable one or more functions of the web application 112. In some embodiments, the UI gateway 104 is configured to transmit the request to a function control module (as discussed above with regards to FIG. 6). In some embodiments, the UI gateway 104 is configured to, in response to receiving the release access request, cause the enactment session to be cleared. For example, the UI gateway 104 transmits a redirect to the web server 102. The web server 102 may be configured to cause the access token and session cookie(s) (e.g., the cookies set by proxy server 110 in FIG. 6) to be cleared in response to receiving the redirect request.

Referring to FIGS. 1-2 and 5A-5B, the system 100 of the present disclosure may be configured to enable the enactment device 106 to mimic multiple authenticated sessions of the web application 112. The UI gateway 104 may be configured to mimic two or more enactment sessions at the enactment UI 120. In some embodiments, the UI gateway 104 is configured to enable a plurality of enactment sessions to be accessed at the enactment UI 120. The UI gateway 104 may be configured to assign enactment sessions mimicking target device(s) 108 to different pages within the enactment UI 120. For example, and as shown in FIG. 5A, the enactment UI 120 includes two tabs 130a, 130b each being associated with enactment sessions for different target devices 108. In FIG. 5A, the first tab 130a is active and the enactment UI 120 is displaying an active enactment session mimicking a first target device 108. In FIG. 5B, the second tab 130b is active and the enactment UI 120 is displaying an active enactment session mimicking a second target device 108.

The UI gateway 104 may be configured to automatically modify a connection of the enactment device 106 and/or target device 108 to a corresponding session of the web application 112. In some embodiments, the UI gateway 104 is configured to detect a user action at the enactment device 106 at the inline frame hosting the web page (e.g., SPA 114) of the web application 112 and, in response to detecting the user action, modify a connection of the target device 108 and enactment device 106 to the web application 112.

For example, the UI gateway 104 detects a selection of the second tab 130b while the first tab 130a is active, as shown in FIG. 5A. In response to detecting the selection of the second tab 130b, the UI gateway 104 is configured to disconnect the enactment device 106 from the enactment session mimicking the first target device 108. In some embodiments, disconnecting the enactment device 106 from an enactment session includes causing, via the UI gateway 104, a session token corresponding to the enactment session to be deleted from the enactment device 106. For example, the UI gateway 104 is configured to clear from the enactment device 106 a session token corresponding to the enactment session mimicking the first target device 108.

In some embodiments, disconnecting the enactment device 106 from an enactment session includes setting a corresponding session token to be inactive via the UI gateway 104. For example, the UI gateway 104 may be configured to inactivate a session token corresponding to an enactment session. In some embodiments, inactivating a session token may include one or more of: setting a server-side flag indicating that the session token is inactive, setting the session token to be expired, adding the session token to a list of revoked tokens, and modifying the session token permissions such that it no longer grants access to one or more resources of the web application 112. In some embodiments, an inactive session token may remain within stored on the enactment device 106 such that it may be activated at a later point in time.

In some embodiments, the UI gateway 104 is configured to disconnect the enactment device 106 from the enactment session mimicking the target device 108 in response to a cursor movement relative to the inline frame hosting the web application 112. The UI gateway 104 may be configured to detect a mouse-out action outside the perimeter of the inline frame hosting the web application 112. For example, the UI gateway 104 may detect that a cursor moves outside the perimeter of the web-shell SPA 118, illustrated in dotted lines in FIG. 5A, and automatically disconnect the enactment session mimicking the first target device 108. The UI gateway 104 may be configured to detect a mouse-over action at a perimeter of the inline frame hosting the web application 112. For example, the UI gateway 104 may detect that a cursor moves over the perimeter of the web-shell SPA 118 in FIG. 5A and automatically disconnect the enactment session mimicking the first target device 108. In FIGS. 5A-5B the perimeter of the web-shell SPA 118 shown in broken lines may also represent the perimeter of the inline frame embedded in the web-shell SPA 118.

In some embodiments, the UI gateway 104 is configured to connect a target device 108 to a session of the web application 112 in response to disconnecting an enactment device 106 from a corresponding enactment session. For example, in FIGS. 5A-5B, a user action corresponding to the selection of the second tab 130b is detected at the UI gateway 104. Further to this example, the UI gateway 104 may be configured to disconnect the enactment device 106 from the enactment session illustrated in FIG. 5A and cause the first target device 108 to connect to a session with the web application 112. In some embodiments, connecting a session of a target device 108 with the web application 112 may include releasing access to the web application 112 for the target device 108 as discussed above.

In some embodiments, the UI gateway 104 is configured to automatically connect the enactment device 106 to a session with the web application 112 that mimics authentication of another target device 108. In FIG. 5A the enactment device 106 receives a selection of the second tab 130b causing the enactment device 106 to display the enactment UI 120 shown in FIG. 5B. The UI gateway 104 may be configured to, in response to detecting the selection of the second tab 130b, create a session token or refresh an already-created session token for the enactment device 106. For example, communications between the UI gateway 104 and the web server 102 may cause a session token corresponding to be created such that the enactment session illustrated in FIG. 5B mimicking the second target device 108 is connected. In instances where a session token corresponding to the enactment session mimicking the second target device 108 is already stored on the enactment device 106, the web server 102 may be configured to set the session token to active such that the enactment session is connected.

In FIGS. 5A-5B two enactment session are illustrated, however it should be understood that the enactment UI 120 may include more than two tabs or windows corresponding to different enactment sessions. The UI gateway 104 may be configured to enable a user at the enactment device 106 to switch between different enactment sessions and automatically connect/disconnect the enactment device 106 from active/inactive enactment sessions. For example, a user at the enactment device 106 may, in FIG. 5B, select the first tab 130a to disconnect the enactment device 106 from the enactment session shown in FIG. 5B and connect the enactment device 106 to the enactment session shown in FIG. 5A. The UI gateway 104 may enable users of the enactment device 106 to easily and quickly switch between different enactment sessions as desired. For example, in some instances the user of the enactment device 106 is a customer service representative providing support to a plurality of different customers via enactment UI 120. In such instances the customer service representative may mimic the plurality of different customers via enactment sessions and be able to switch between different enactment sessions on the enactment UI 120 to the customers simultaneously.

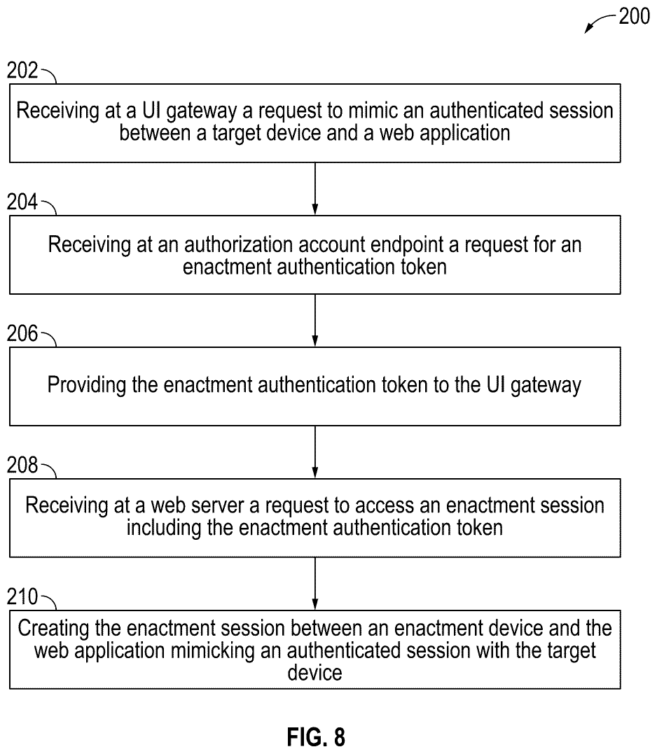

Referring to FIG. 8 there is shown a flowchart illustrating a method, generally designated 200, in accordance with an exemplary embodiment of the present disclosure. In some embodiments, the method 200 includes the step 202 of receiving, at a UI gateway, a request from an enactment device to mimic an authenticated session between a target device and a web application hosted at a web server, the target device having a target device identifier. For example, the UI gateway 104 may be configured to receive a request from enactment device 106 to mimic an authenticated session between a target device 108 and the web application 112 hosted by the web server 102. As discussed above, the target device 108 may have a target device identifier (e.g., a unique id, a customer id) that is transmitted to the UI gateway 104 with the request to mimic an authenticated session of the target device 108 and the web application 112.

In some embodiments, the method 200 includes the step 204 of receiving, at a company-specific authorization account endpoint, a request from the UI gateway for an enactment authentication token, the request including the target device identifier and a token associated with the enactment device. For example, the UI gateway 104 may be configured to transmit a request to the authorization account endpoint 116 for an enactment token. The UI gateway 104 may be configured to include in the request: 1) the target device identifier corresponding to the target device 108 for which the mimicked session is desired; and 2) a token associated with the enactment device 106 that requested to mimic the authenticated session in step 202. In some embodiments, the UI gateway 104 is configured to generate the token associated with the enactment device 106 in response to a user of the enactment device authenticating with the enactment UI 120. For example, the enactment UI 120, illustrated in FIGS. 4-5B, may be a web application hosted by the UI gateway 104, which requires authentication to access. Further to this example, in response to a successful authentication with the enactment UI 120 the UI gateway 104 may be configured to request a corresponding token and transmit the token to the enactment device 106.

In some embodiments, the method 200 includes the step 206 of providing, by the company-specific authorization account endpoint, the enactment authentication token to the UI gateway. For example, the authorization account endpoint 116 may be configured to validate the request for an enactment authentication token from the UI gateway 104 and in response to validating the request generate and transmit the enactment authentication token to the UI gateway 104. In some embodiments, the enactment authentication token provided to the UI gateway includes one or more of: a unique identifier of the enactment device, a permission identifier, and the target device identifier. For example, the enactment authentication token transmitted to the UI gateway 104 may include an ID token including data corresponding to the unique identifier of the enactment device and the target device and an access token including data corresponding to permissions of the UI gateway 104 and/or enactment device 106 with regards to the web application 112 as discussed above with regards to FIGS. 1-2.

In some embodiments, the method 200 includes the step 208 of receiving via the UI gateway, at a proxy server being at the same internet domain as the web server, a request to access an enactment session with the web application at the enactment device, the request including the enactment authentication token. For example, the UI gateway 104 may be configured to transmit to the web server 102, via proxy server 110, a request including the enactment authentication token, to create an enactment session with the web application 112. As discussed above with regards to FIGS. 1-2, the proxy server 110 and web server 102 may be at the same internet domain as one another.

In some embodiments, the method 200 includes the step 210 of creating, at the web server, via the proxy server, the enactment session between the enactment device and the web application, wherein the enactment session between the enactment device and the web application mimics an authenticated session between the web application and the target device. As discussed above with regards to FIGS. 1-6, the web server 102 may be configured to receive the enactment authentication token and create an enactment session between the enactment device 106 and the web application 112 that mimics an authenticated session between the web application 112 and the target device 108. For example, and as illustrated in FIG. 4, the enactment UI 120 displays at the enactment device 106 an enactment session within web-shell SPA 118.

In some embodiments, creating the enactment session includes setting an access token cookie and a session cookie specific to the enactment device. The web server 102, via proxy server 110, may be configured to set an access token cookie and a session cookie specific to the enactment device 106.

In some embodiments, the method 200 further includes receiving, at the web server, a request from the target device to access an authenticated session of the web application, and creating, by the web server, the authenticated session between the target device and the web application. For example, the web server 102 may be configured to receive a request from the target device 108 to access an authenticated session of the web application 112 and create an authenticated session between the target device 108 and the web application 112 as illustrated in FIG. 3.

In some embodiments, the method 200 further includes disabling, by the web server, at least one function of the authenticated session between the target device and the web application. For example, and as discussed above with regards to FIGS. 1-2, the web server 102 may be configured to disable a function of the web application 112 for sessions with a target device 108 in response to an enactment session mimicking the target device 108 being created. As discussed above, the at least one function may include a cart function for the web application 112 but is not limited thereto.

In some embodiments, the method 200 further includes detecting, at the UI gateway, a request to release access to the authenticated session of the web application for the target device and enabling, by the web server, at least one function of the authenticated session of the web application for the target device previously disabled by the UI gateway. For example, the UI gateway 104 may be configured to detect a request to release access to the session between the web application 112 and target device 108 and the web server 102 may be configured to automatically enable the function of the web application previously disabled (e.g., enable the cart function).

In some embodiments, the method 200 further includes transmitting a release access request from the UI gateway to the web server, and clearing, by the web server, the enactment session between the enactment device and the web application, wherein clearing the enactment session includes deleting an access token cookie and a session token cookie. For example, the UI gateway 104 may be configured to, via web-shell SPA 118, transmit the release access request to the web server 102. The web server 102 may be configured to receive the release access request and clear the enactment session by causing the access token cookie and/or session token cookie stored on the enactment device to be deleted or set to an inactive state.

In some embodiments, the request to release access to the instance of the web application intended for the target device is a mouse-out or mouse-over event detected by the UI gateway. For example, and as discussed above with regards to FIGS. 5A-5B, the UI gateway 104 may be configured to detect mouse-out and/or mouse-over events at the web-shell SPA 118 rendered on the enactment UI 120. In response to detecting the mouse-out and/or mouse-over event at the web-shell SPA 118 the UI gateway 104 may be configured to transmit to the web server 102 the request to release access to a session of the web application 112 at the target device 108.

In some embodiments, transmitting a release access request includes, by the UI gateway, transmitting the request to an inline frame embedded in the UI gateway that is on the internet domain of the web application. For example, the UI gateway 104 may be configured to transmit the release access request to the web server 102 via the web-shell SPA 118, which may be on the same internet domain as the web server 102.

Referring to FIG. 7, there is shown a flowchart illustrating a method, generally designated 300, in accordance with an exemplary embodiment of the present disclosure. The method 300 may include the step 302 of receiving, from a UI gateway, a request from an enactment device to mimic an authenticated session between a web application hosted by a web server and a target device. For example, and as discussed above with regards to FIGS. 1-2, the UI gateway 104 may be configured to receive a request from enactment device 106 to mimic an authenticated session between the web application 112 and a target device 108. In some embodiments, the UI gateway includes an inline frame embedding a web-shell SPA therein. For example, the UI gateway 104 may include inline frame embedding web-shell SPA 118 therein, as discussed above with regards to FIGS. 1-2. In some embodiments, the web-shell SPA is configured to connect the UI gateway to the web server. For example, and as discussed above, the web-shell SPA 118 may be on the same internet domain as the web server 102 and may include one or more permissions that enable the UI gateway 104 and web server 102 to exchange data (e.g., cross-domain messaging).

In some embodiments, the UI gateway operates on a different internet domain than the web-shell SPA and the web server and wherein the web server restricts direct access to the web application for the UI gateway. For example, the web server 102 may be configured to restrict direct access thereto from servers operating on a different domain, such as the UI gateway 104. Accordingly, the web server 102 may be configured to restrict the direct exchange of data with the UI gateway 104. However, and as discussed above, the web-shell SPA 118 may include a set of permissions that enables the direct exchange of data with the UI gateway 104 regardless of the web-shell SPA 118 and UI gateway 104 operating at different internet domains. The web-shell SPA 118 may enable data (e.g., computer executable code, Javascript, HTML, CSS) to be received from the UI gateway 104 and transmitted to the web server 102, as discussed above with regards to FIGS. 1-5.

In some embodiments, the method 300 includes the step 304 of transmitting, from the web server to the web-shell SPA, a respective web page of the web application. For example, the web server 102 may be configured to cause the proxy server 110 to transmit a SPA 114 of the web application 112 to the web-shell SPA 118. In some embodiments, the proxy server 110 is configured to modify the SPA 114, via web-shell SPA 118, and transmit the modified SPA 114 to the UI gateway 104 for display at the enactment device 106. In some embodiments, the web server 102 is configured to transmit a SPA 114 of the web application 112 to the web-shell SPA 118.

In some embodiments, the method 300 includes the step 306 of displaying at the enactment device in communication with the UI gateway, the web application including the inline frame embedding the web-shell single-page application and an inline frame hosting the respective web page of the web application. For example, and as illustrated in FIG. 4, the enactment device 106 displays enactment UI 120, which includes a display of the web application 112, or a SPA 114 thereof, within the perimeter of the web-shell SPA 118 and/or inline frame.

In some embodiments, the method 300 includes the step 308 of detecting a user action at the enactment device at the inline frame hosting the web page of the web application. For example, and as discussed above with regards to FIGS. 4-5, the UI gateway 104 detects a user action at the enactment device 106 in FIG. 4 in which the cursor moves outside the perimeter of the web-shell SPA 118 and a selection of the second tab 130b.

In some embodiments, the method 300 includes the step 310 of, in response to detecting the user action, modifying a connection of the target device and the enactment device to the web application. For example, and as discussed above with regards to FIGS. 5A-5B, in response to detecting the movement of the cursor and/or selection of the second tab 130b, the UI gateway 104 causes the connection of the enactment device 106 and the first target device 108 to be modified. In some embodiments, modifying a connection of the enactment device 106 to the web application 112 includes connecting the enactment device 106 to a session with the web application 112 that mimics an authentication of the target device 108. For example, in FIGS. 5A-5B the enactment device 106 is connected to an enactment session with the web application 112 that mimics authentication of a target device 108.

In some embodiments, the method 300 further includes disconnecting the enactment device from the session with the web application that mimics authentication of the target device, connecting the target device to a session with the web application, and connecting the enactment device to a session with the web application that mimics authentication of a second target device. For example, and as discussed above with regards to FIGS. 5A-5B, the UI gateway 104 causes the enactment device 106 to be disconnected from the enactment session mimicking the first target device 108 (e.g., shown in FIG. 5A), connects the first target device to a session with the web application 112, and connects the enactment device 106 to an enactment session mimicking a second target device 108 (e.g., shown in FIG. 5B).

In some embodiments, the method 300 includes detecting and modifying one or more elements of the respective web page at the web-shell before displaying the respective web page at the enactment device. The UI gateway 104 may be configured to cause elements of the web application 112 to be modified for display at the enactment UI 120 rendered at the enactment device 106. For example, and as discussed above with regards to FIGS. 3-4, the UI gateway 104 causes the banner 122′ illustrated in FIG. 4 to be modified in when compared to the banner 122 displayed on a target device 108 illustrated in FIG. 3.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”. Finally, unless specifically set forth herein, a disclosed or claimed method should not be limited to the performance of their steps in the order written, and one skilled in the art can readily appreciate that the steps may be performed in any practical order.

1. A method, comprising:
receiving, at a UI gateway, a request from an enactment device to mimic an authenticated session between a target device and a web application hosted at a web server, the target device having a target device identifier;
receiving, at a company-specific authorization account endpoint, a request from the UI gateway for an enactment authentication token, the request including the target device identifier and a token associated with the enactment device;
providing, by the company-specific authorization account endpoint, the enactment authentication token to the UI gateway;
receiving via the UI gateway, at a proxy server being at the same internet domain as the web server, a request to access an enactment session with the web application at the enactment device, the request including the enactment authentication token; and
creating, at the web server, via the proxy server, the enactment session between the enactment device and the web application,
wherein the enactment session between the enactment device and the web application mimics an authenticated session between the web application and the target device.

2. The method of claim 1 further comprising:
receiving, at the web server, a request from the target device to access an authenticated session of the web application; and
creating, by the web server, the authenticated session between the target device and the web application.

3. The method of claim 2, further comprising:
detecting, at the UI gateway, a request to release access to the authenticated session of the web application for the target device;
enabling, by the UI gateway, at least one function of the authenticated session of the web application for the target device previously disabled by the UI gateway;
transmitting a release access request from the UI gateway to the web server; and
clearing, by the web server, the enactment session between the enactment device and the web application, wherein clearing the enactment session includes deleting an access token cookie and a session token cookie.

4. The method of claim 3, wherein the request to release access to the instance of the web application intended for the target device is a mouse-out or mouse-over event detected by the UI gateway.

5. The method of claim 3, wherein transmitting a release access request includes, by the UI gateway, transmitting the request to an inline frame embedded in the UI gateway that is on the internet domain of the web application.

6. The method of claim 2 further comprising:
disabling, by the UI gateway, at least one function of the authenticated session between the target device and the web application.

7. The method of claim 6, wherein the at least one function includes a cart function for the web application.

8. The method of claim 1, wherein the web application includes a plurality of single page applications hosted by the web server at the same internet domain as the proxy server.

9. The method of claim 1, wherein the web server restricts requests for session creation of the web application from servers operating on a different internet domain and wherein the UI gateway is a server that operates on a different internet domain than the web server.

10. The method of claim 1, wherein the enactment authentication token provided to the UI gateway includes one or more of: a unique identifier of the enactment device, a permission identifier, and the target device identifier.

11. The method of claim 1, wherein creating the enactment session includes setting an access token cookie and a session cookie specific to the enactment device.

12-20. (canceled)

21. A system comprising:
a UI gateway configured to receive a request from an enactment device to mimic an authenticated session between a target device and a web application hosted at a web server, the target device having a target device identifier;
a company-specific authorization account endpoint configured to:
receive a request from the UI gateway for an enactment authentication token, the request including the target device identifier and a token associated with the enactment device; and
provide the enactment authentication token to the UI gateway; and
a proxy server being at the same internet domain as the web server and configured to receive a request to access an enactment session with the web application at the enactment device, the request including the enactment authentication token,
wherein the web server is configured to, via the proxy server, create the enactment session between the enactment device and the web application, and
wherein the enactment session between the enactment device and the web application mimics an authenticated session between the web application and the target device.

22. The system of claim 21, wherein the web server is further configured to:
receive a request from the target device to access an authenticated session of the web application; and
create the authenticated session between the target device and the web application.

23. The system of claim 22, wherein the UI gateway is further configured to:
detect a request to release access to the authenticated session of the web application for the target device,
enable at least one function of the authenticated session of the web application for the target device previously disabled by the UI gateway, and
transmit a release access request from the UI gateway to the web server,
wherein the web server is further configured to clear the enactment session between the enactment device and the web application, and
wherein clearing the enactment session includes deleting an access token cookie and a session token cookie.

24. The system of claim 23, wherein the web server, via a web-shell SPA of the web application, is further configured to detect a mouse-out or mouse-over event and transmit the request to release access to the instance of the web application intended for the target device.

25. The system of claim 23, wherein the UI gateway is configured to transmit the release access request to an inline frame embedded in the UI gateway that is on the internet domain of the web application.

26. The system of claim 22, wherein the web server is further configured to disable at least one function of the authenticated session between the target device and the web application.

27. The system of claim 26, wherein the at least one function includes a cart function for the web application.

28. The system of claim 21, wherein the web application includes a plurality of single page applications hosted by the web server at the same internet domain as the proxy server.

29. The system of claim 21, wherein the web server is configured to restrict requests for session creation of the web application from servers operating on a different internet domain, and
wherein the UI gateway is a server that operates on a different internet domain than the web server.

30. The system of claim 21, wherein the enactment authentication token includes one or more of: a unique identifier of the enactment device, a permission identifier, and the target device identifier.

31. The system of claim 21, wherein the web server is further configured to, via the proxy server, set an access token cookie and a session cookie specific to the enactment device.

32-40. (canceled)
